(19) United States
(12) Patent Application Publication
(10) Pub. No.: US 2008/0307344 A1
(43) Pub. Date: Dec. 11, 2008

(54) Plant Monitoring Equipment and Plant Operation Monitoring Method

(75) Inventors: Nobuhisa OSAKI, Mito (JP); Katsuhito Shimizu, Hitachi (JP); Kenichi Tamaru, Hitachi (JP); Kousuke Yamaguchi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/132,687

(22) Filed: Jun. 4, 2008

(30) Foreign Application Priority Data
Jun. 7, 2007 (JP) 2007-151376

(51) Int. Cl. G06F 3/048

(52) U.S. Cl. 715/766

(57) ABSTRACT

A plant monitoring apparatus and a plant operation monitoring method are disclosed, wherein the plant monitoring apparatus includes a display unit for displaying a plant monitor screen having a plurality of windows displayed in superposition with each other, a monitor unit for monitoring a status change of the plant, and a control unit for transparently displaying at least a partial area of the superposed window upon detection of a status change of the plant by the monitor unit.

### BACKGROUND OF THE INVENTION

This invention relates to a plant monitoring equipment (apparatus) and a plant operation monitoring method suitably used for operation, monitoring and maintenance of, for example, a sewage treatment plant, a power plant or a factory.

In the conventional monitoring apparatus, the monitor operation using a plant monitor screen with multiwindow display finds wide applications. In multiwindow display, a plurality of different monitor screens can be displayed in superposition with each other on a monitoring apparatus. Therefore, the amount of the information displayed on the monitoring apparatus is remarkably increased (for example, see JP-A-11-345023, paragraph 0006, FIG. 1).

In recent years, the 3D graphic function of the hardware of the monitoring apparatus and the aero function provided by the OS (Operating System) such as Windows VISTA (registered trademark) have come to be utilized to transparently display the window on the front of the windows displayed in superposed relation with each other. Without switching the windows, therefore, a rear window can be recognized, thereby increasing the amount of information displayed while at the same time improving the operability.

A multiplicity of patent applications have conventionally been filed for the conventional techniques for transparent display of the windows displayed in superposition with each other. In a plant monitoring application, for example, a control display device is known in which the transmittance of an alarm window displayed in keeping with a plant alarm is changed according to the alarm level (for example, JP-A-2005-267267, paragraphs 0008 to 0010, FIG. 1).

### SUMMARY OF THE INVENTION

In the conventional transparent window display function described above, however, the window transmittance is preset and fixed or, if variable, required to be consciously set by the operator numerically or using a slide bar or the like. As a result, a rear window behind a window not set for transparent display is in a hidden state.

Also, according to the technique disclosed in JP-A-2005-267267 described above, the display of the alarm window changes the object of operation to the alarm window, and at this time point, the operation being performed by the operator is required to be suspended. This poses the problem of a low operation efficiency and an operating inconvenience.

This invention has been achieved to solve the aforementioned problem, and the object thereof is to provide a plant monitoring apparatus and a plant operation monitoring method in which the transparent display is conducted dynamically while supplying a great amount of information to the operator and the apparatus can be operated efficiently without interrupting the ongoing plant operation by the operator.

In order to achieve the object described above, according to this invention, there is provided a plant monitoring apparatus comprising a display unit for displaying a plant monitor screen having a plurality of windows displayed in superposed relation to each other, a monitor unit for monitoring a status change of the plant, and a control unit for transparently displaying at least a partial area of the windows displayed in superposition with each other on the display unit. At the time of selective operation of the window for transparently displaying at least a partial area, the control unit also displays an operating tool for the plant displayed on the transparently displayed window, and by detecting the operation of the particular operating tool, performs the plant control operation.

In the configuration described above, assume that a window high in priority is hidden in superposed relation behind a window low in priority. Upon detection of a status change of the plant in the front window low in priority, at least a partial area of the front window is transparently displayed thereby to dynamically reflect the plant status change. Also, the operator can continue the operation without switching the windows.

With the plant monitoring apparatus according to this invention, a great amount of information are supplied to the operator with dynamic transparent display, and therefore, the operation can be performed efficiently by the operator without interrupting the ongoing plant operation.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an example of the system configuration of a plant operation monitoring system connected with a plant monitoring apparatus according to an embodiment of the invention.

FIG. 2 is a block diagram showing, in the form of a functional development, the internal configuration of a control unit 21 shown in FIG. 1.

FIG. 3 is a diagram showing an example of the data structure of the priority information indicating the priority value by window type stored in a priority information storage unit shown in FIG. 2.

FIG. 4 is a diagram showing another example of the data structure of the priority information indicating the priority value of the display factors stored in the priority information storage unit shown in FIG. 2.

FIG. 5 is a diagram showing an example of the data structure of the transmission information stored in a transmission information storage unit shown in FIG. 2.

FIG. 6 is a flowchart showing the operation of the plant monitoring apparatus according to an embodiment of the invention.

FIG. 7 is a diagram showing an example of the screen configuration generated by the plant monitoring apparatus according to an embodiment of the invention.

FIG. 8 is a diagram showing an example of the screen configuration generated by the plant monitoring apparatus according to an embodiment of the invention.

FIG. 9 is a diagram showing an example of the screen configuration generated by the plant monitoring apparatus according to an embodiment of the invention.

FIG. 10 is a diagram showing an example of the screen configuration generated by the plant monitoring apparatus according to an embodiment of the invention.

FIG. 11 is a sequence diagram showing an example of the process of the plant operation monitoring method according to an embodiment of the invention.

FIG. 12 is a sequence diagram showing another example of the process of the plant operation monitoring method according to an embodiment of the invention.

### DETAILED DESCRIPTION OF THE EMBODIMENTS

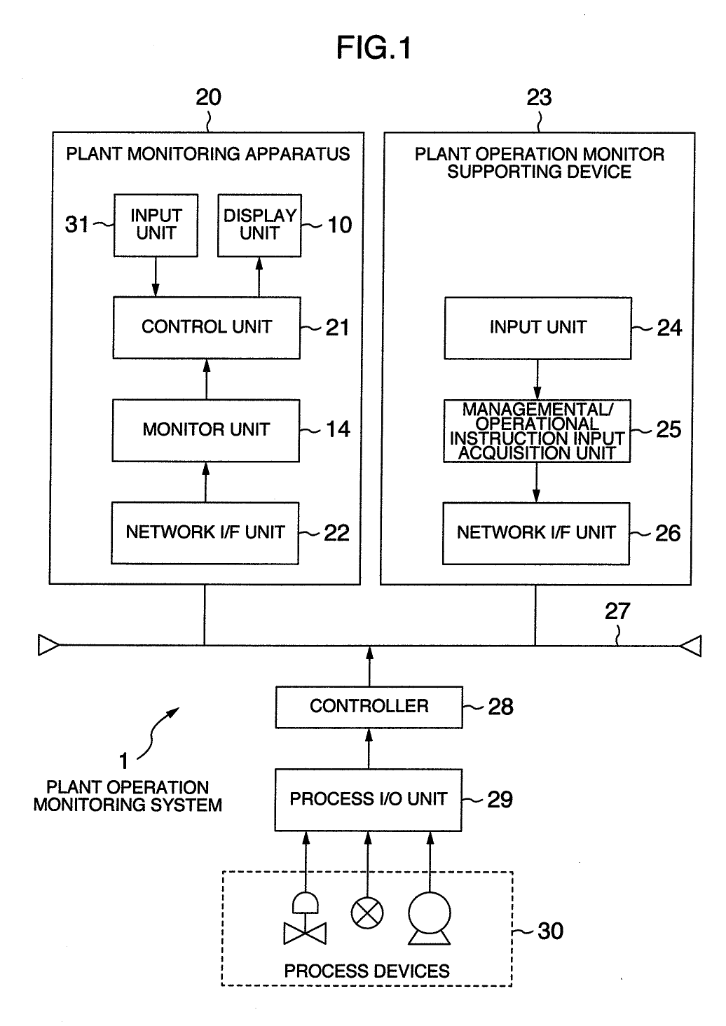

FIG. 1 is a diagram showing an example of the system configuration of a plant operation monitoring system having a plant monitoring apparatus according to an embodiment of the invention.

As shown in FIG. 1, the plant operation monitoring system 1 includes a plant monitoring apparatus 20, a plant operation monitor supporting device 23 and a controller 28 connected to each other through a network 27 such as LAN (Local Area Network) or WAN (Wide Area Network). The controller 28 is connected with a process device 30 such as a pump, a valve or a sensor through a process input/output (I/O) device 29.

In the plant monitoring apparatus 20, a plurality of screens (windows) for operation monitoring, managemental/operational instruction and maintenance are displayed, according to the multiwindow display function provided by the OS, on the display unit 10 such as a liquid crystal monitor based on the screen data plotted in a display memory described later.

For this purpose, the plant monitoring apparatus 20 includes the display unit 10, a control unit 21, a monitor unit 14, a network interface (I/F) unit 22 and an input unit 31.

As described above, the display unit 10 displays a plant monitor screen having a plurality of windows in superposition with each other. The monitor unit 14, on the other hand, monitors and detects a status change of the plant and delivers the result to the control unit 21. In The control unit 21, upon detection of a status change of the plant by the monitor unit 14, transparently displays at least a partial area of the windows displayed in superposition on the display unit 10.

Incidentally, the network I/F unit 22, in charge of interface with the network 27, constitutes a data exchange path with the plant operation monitor supporting device 23 and the controller 28. Also, the input unit 31, operated by the operator, selects the windows displayed on the display unit 10 and conducts the operation input for an operating tool displayed in the windows. In the process, the control unit 21, upon selection of a window with at least a partial area transparently displayed, displays a plant operating window for plant devices or process devices of the plant which are displayed by the transparently displayed window and performs the corresponding plant control operation by detecting the operation of the operating tool.

The managemental or operational instructions including the plant equipment maintenance timing, the operation time limit, the maintenance timing to start and end the construction, the instruction on the production quantity, the designation of the shipment time and the shift of the operators, on the other hand, are given by the manager operating the input unit 24 of the plant operation monitor supporting device 23. The instructions input through the input unit 24 are retrieved by a managemental/operational instruction input acquisition unit 25 and, by being converted into an electric instruction mail, transmitted to the network 27 through the network I/F unit 26.

The electric mail generated by the plant operation monitor supporting device 23 is transmitted to the network I/F unit 22 of the plant monitoring apparatus 20 through the network 27 and delivered to the monitor unit 14. The monitor unit 14 monitors a plant status change in accordance with the contents designated in the electric mail.

The “plant status change” is defined as any the breakpoints of the plant operation phase including an anomaly of the plant equipment, the process amount or the operating condition, and the operation preparation start, the operation start, the stop instruction, the stop preparation or the stop completion. These breakpoints are detected by the controller 28 with the process state acquired by the process I/O device 29 as a trigger. The state change of the process devices 30 is thus converted into an electric mail and transmitted to the network 27.

The monitor unit 14 of the plant monitoring apparatus 20 interprets the received electric mail and delivers it to the control unit 21. The control unit 21 determines the transmittance of the windows displayed in superposition with each other in accordance with predetermined conditions, and by issuing a transparent window display request to the hardware or OS, transparently displays the superposed windows on the display unit 10.

The “transparent display” is defined as a display situation in which the brightness of the background between the superposed windows is wholly or partially changed to give the transmission effect to the front window (or the display factors in the window), and the “transmittance” as the ratio at which the rear window is visible through the front window. The transmittance of 100% indicates the situation in which the rear window is fully visible through the front window and 0% as the situation in which the rear window is hidden behind the front window and invisible.

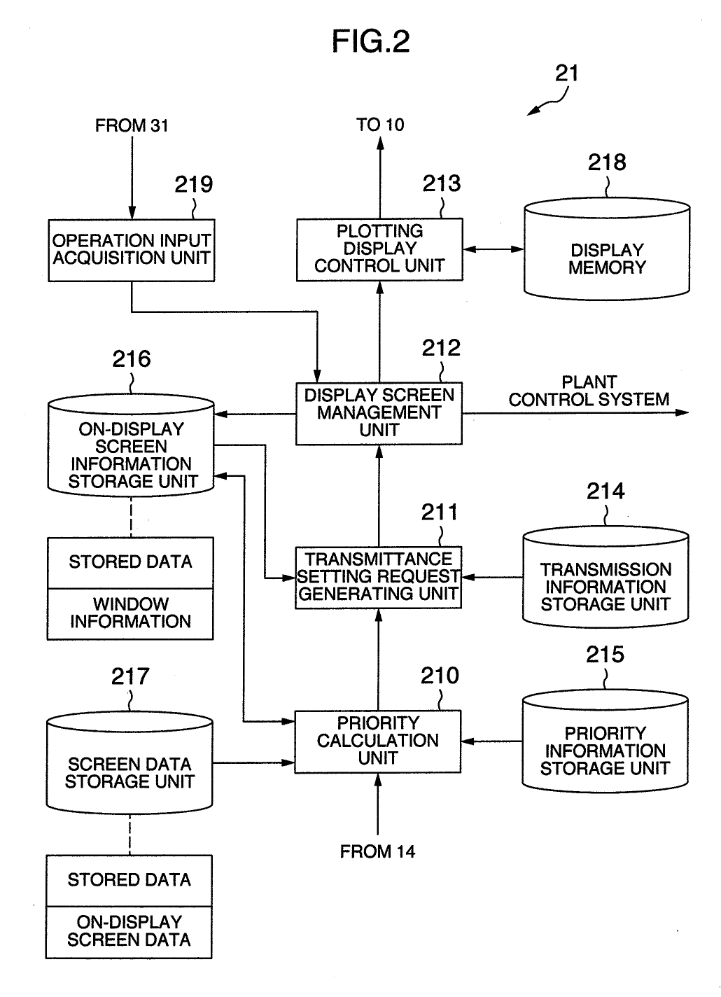

FIG. 2 is a block diagram showing the development of the functions included in the internal configuration of the control unit 21 shown in FIG. 1. As shown in FIG. 2, the control unit 21 is configured of a peripheral LSI including a microprocessor and a memory (neither is shown) in terms of hardware on the one hand and functionally configured of a priority calculation unit 210, a transmittance setting request generating unit 211, a display screen management unit 212, a plotting (or drawing) display control unit 213, a transparent information storage unit 214, a priority information storage unit 215, an on-display screen information storage unit 216, a screen data storage unit 217, a display memory 218 and an operation input acquisition unit 219 on the other hand.

The priority calculation unit 210, with the detection of a status change of the plant by the monitor unit 14 as a motive, calculates the priority for each of the superposed windows or each display factor and the priority difference between the superposed windows or between the display factors. Then, the information on the priority difference generated as the result of calculation is supplied to the transmittance setting request generating unit 211.

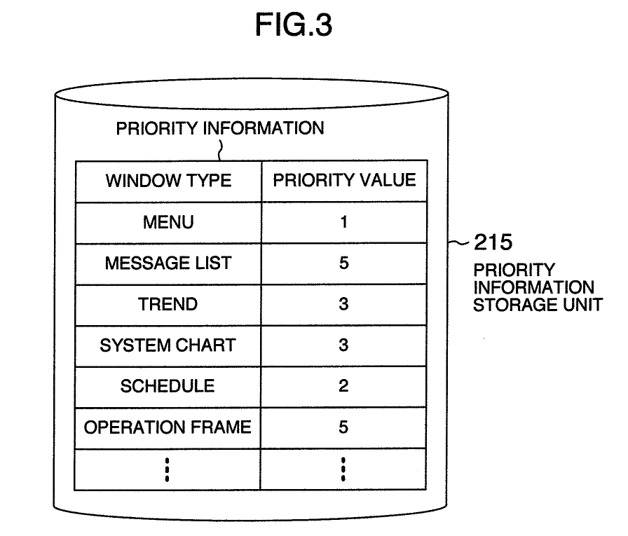

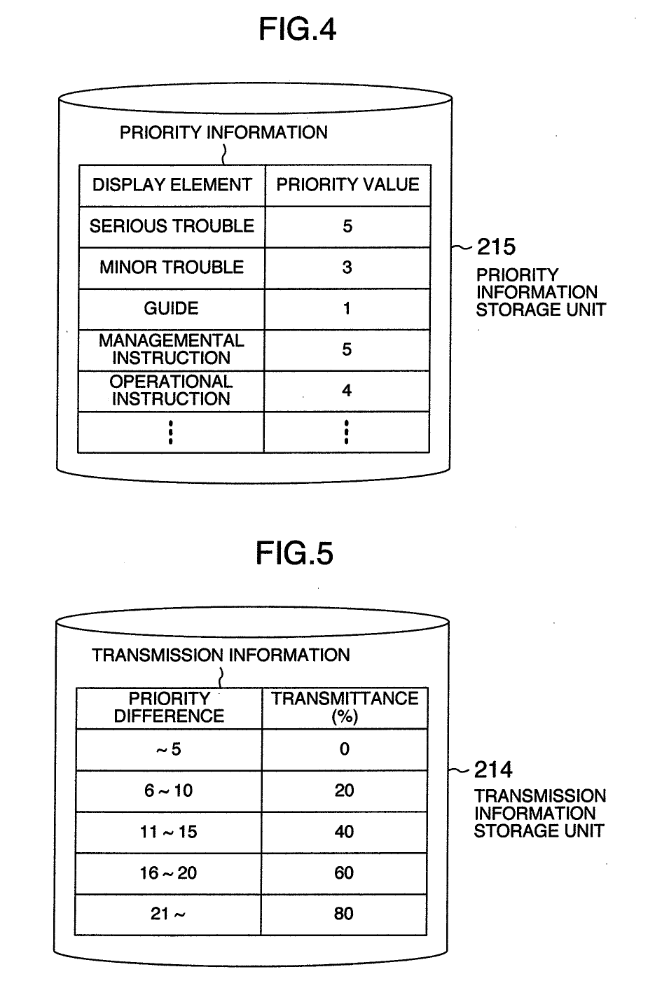

FIG. 3 shows an example of the priority information indicating the priority value by window type, and FIG. 4 an example of the priority information indicating the priority values of the display factors.

The priority calculation unit 210, as an example of the data structure thereof is shown in FIGS. 3 and 4, acquires the priority value defined for each window type or display factor, and with reference to the screen information stored in the screen data storage unit 217 and the on-display screen information storage unit 216, calculates the priority difference for each window displayed in superposition on the display unit 10 or for each display factor. The priority values shown in FIGS. 3 and 4 are described in detail later.

Incidentally, as described later, the window priority value is calculated using the priority value by window type shown in FIG. 3 and the priority values of the display factors shown in FIG. 4.

The transmittance setting request generating unit 211, in accordance with the transmittance preset for each priority difference calculated by the priority calculation unit 210, generates a transmittance setting request to transparently display at least a partial area of the windows on the display unit 10 and supplies it to the display screen management unit 212.

FIG. 5 shows an example of the data structure of the transmission information stored in the transmission information storage unit 214 shown in FIG. 2.

The transmittance setting request generating unit 211, as shown in FIG. 5, supplies the display screen management unit 212 with the transmittance preset and stored in the transmission information storage unit 214. The transmittance shown in FIG. 5 is described in detail later.

The display screen management unit 212 generates and supplies the plotting display control unit 213 with the screen information (multiwindow) to be displayed on the display unit 10 in accordance with the transmittance setting request (transmittance) supplied from the transmittance setting request generating unit 211. The plotting display control unit 213 plots, in the display memory 218, the screen information generated by the display screen management unit 212, while at the same time reading and displaying the screen information plotted in the display memory 218, in synchronism with the display timing of the display unit 10. Incidentally, the display memory 218 has a storage capacity equivalent at least to the screen capacity of the display unit 10.

Incidentally, the on-display screen information storage unit 216 has stored therein the information (one of the window types) on each window being displayed on the display unit, and the screen data storage unit 217 has stored therein the on-display screen data (one of the display factors) in the particular window.

In the operation input acquisition unit 219, the select information of the window acquired by the operator through the input unit 31 and displayed on the display unit 10 and the instruction input to the operating tool displayed in the window are retrieved and supplied to the display screen management unit 212. In the case where a window with at least a partial area transparently displayed is selected, the display screen management unit 212 displays the operating tool for the plant (one of the display factors) displayed on the transparently displayed window, and upon detection the operation of the operating tool, generates a control signal for controlling the corresponding process device 30, which control signal is output to a plant control system not shown.

The “operating tool” is defined as an operating window displayed at the display position corresponding to the window (one of the display factors) with at least a partial area transparently displayed.

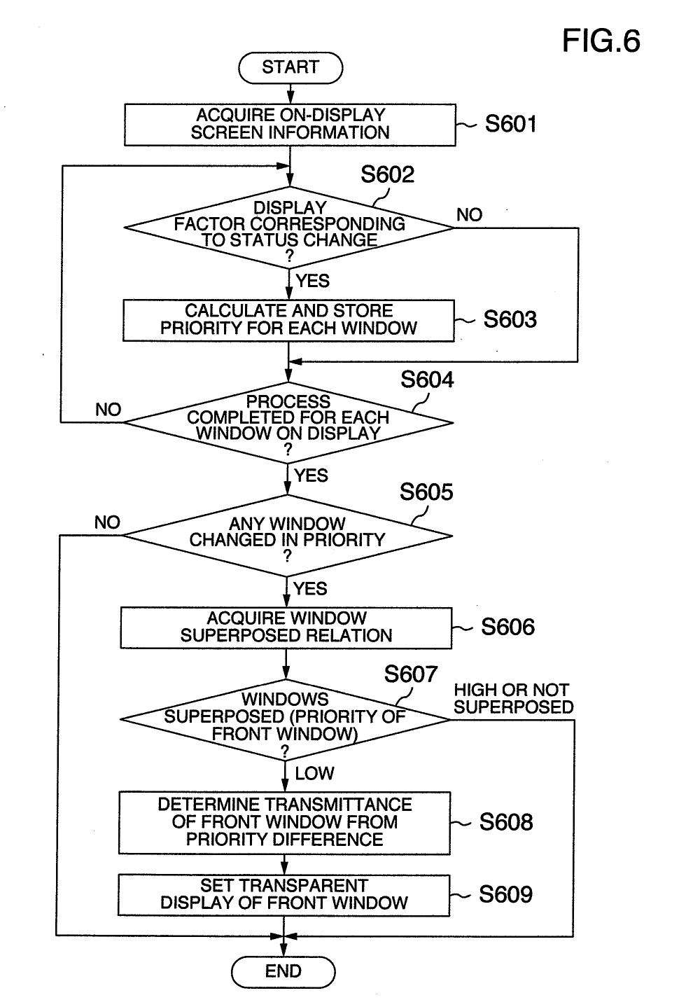

FIG. 6 is a flowchart showing the operation of the plant monitoring apparatus 20 according to an embodiment of the invention.

With reference to the flowchart shown in FIG. 6, the operation of the plant monitoring apparatus 20 according to an embodiment of the invention shown in FIGS. 1 to 5 is explained in detail below.

The plant monitoring apparatus 20 activates the control unit 21 in accordance with the plant status change detected by the monitor unit 14, and the priority calculation unit 210 of the control unit 21 calculates the priority of each of the windows and the priority difference between the windows displayed in superposition.

In calculating the priority, the priority calculation unit 210 first acquires the on-display screen information managed by the display screen management unit 212, with reference to the on-display screen information storage unit 216 (step S601). The priority calculation unit 210, also referring to the screen data storage unit 217 based on the window type of the on-display screen information, specifies the on-display screen data from among the screen data stored in the screen data storage unit 217. Then, the priority calculation unit 210 judges whether the display factors in the specified on-display screen data include the display factor corresponding to the plant status change detected by the monitor unit 14 (step S602).

The on-display screen information includes the information on each window displayed on the screen. In the case where two windows exist in the display screen, for example, there are also two pieces of window information included.

Examples of the display factors corresponding to the plant status change include a plant device which has developed a serious or minor trouble or a plant device for which a guidance, an operational instruction or a managemental instruction has been given.

Assume that the process of step S602 judges that the display factors in the specified on-display screen includes a display factor corresponding to the status change (YES in step S602). The priority calculation unit 212 calculates the priority of each window including the particular display factor, and holds it in the on-display screen information storage unit 216 managed by the display screen management unit 212 (step S603). Upon judgment that the display factors contained in the specified on-display screen data include no display factor corresponding to the status change (NO in step S602), on the other hand, the process proceeds to step S604 by skipping the priority calculation and holding process of step S603. The operation described above (steps S602 and S603) is repeated as many times as the windows on display (step S604).

Incidentally, the process shown in the flowchart of FIG. 6 is executed at predetermined intervals, and the addition or deletion of the windows is carried out as occasion demands.

Next, the process proceeds to the transmittance setting request generating unit 211 for judging whether there exists a window of which the priority is changed (step S605). Upon judgment that there exists such a window (YES in step S605), the priority calculation unit 210 acquires the superposed relation between the windows (step S606) and judges the superposition between the window of which the status has changed and the other windows (step S607). In the case where the windows are superposed and the front one of the windows is lower in priority (LOW in step S607), then the priority difference between the windows is calculated and delivered to the transmittance setting request generating unit 211.

The transmittance setting request generating unit 211 determines the transmittance of the front window based on the information on the priority difference obtained from the priority calculation unit 210 (step S608), and transfers the control to the display screen management unit 212, which in turn sets the transparent display of the front window in the hardware or OS (step S609). Incidentally, in the case where the front window is higher in priority or no window is found in superposed relation in step S607 (“HIGH OR NOT SUPERPOSED” in step S607), nothing is done.

Upon judgment that there is no window of which the priority has changed (NO in step S605), on the other hand, all the steps are terminated, and the process is executed again from step S601 at predetermined intervals.

Now, the priority calculation process (step S603) and the transmittance determining process (step S608) are explained in detail below.

The priority is calculated by the priority calculation unit 210 based on the priority information stored in the priority information storage unit 215. The priority information, as an example of the data structure thereof is shown in FIG. 3, is the priority value set for each window type or, as an example of the data structure thereof is shown in FIG. 4, is the priority value set for each display factor. The “window type”, as an example thereof is shown in FIG. 3, includes a menu, a message list, trend, a system chart, a schedule or an operation frame. The “display factor” includes, as an example thereof is shown in FIG. 4, includes a serious trouble, a minor trouble, a guide, an operational instruction or a managemental instruction, for each of which a priority value is defined. This priority values may be set in advance by the designer or the operation manager of the plant monitoring apparatus 20 or, as described later, may be determined as a value supplied through the network from the server managed or operated by the plant operation monitor supporting company or the plant maintenance supporting company taking charge of the operation monitoring and maintenance of the plant.

The priority value of the window on display is calculated based on the priority value by window type and the sum of the priority values of the display factors associated with the particular window ((priority value by window type)+(Σpriority values of display factors)).

In the case where one pump in serious trouble and three pumps in minor trouble exist in the system chart on display, for example, the relation holds that 3 (system chart)+5 (serious trouble)×1+3 (minor trouble)×3=17, indicating that the priority value of the window on display is 17.

Incidentally, the priority value by window type shown in FIG. 3 and the priority value for each display factor shown in FIG. 4 are not fixed except for the menu window but can be set freely taking the plant size, plant type, plant status change frequency, the operator characteristic, etc. into consideration.

The priority calculation unit 210 further calculates the priority difference between the superposed windows with reference to the priority for each window on display which is stored in the on-display screen information storage unit 216 and the superposition relation of the windows displayed on the display unit 10. Specifically, the priority calculation unit 210 delivers to the transmittance setting request generating unit 211 the information on the priority difference obtained by subtracting the priority of the front window from the priority of the rear window in superposition with each other.

The transmittance setting request generating unit 211, based on the information on the priority difference calculated by the priority calculation unit 210, accesses the transmission information storage unit 214 with an example of the data structure thereof shown in FIG. 5, determines the transmittance of the front window from the relation between the transmittance and the priority difference stored in the transmission information storage unit 214, and gives a window transmittance setting request to the display screen management unit 212. As a result, the display screen management unit 212, by reference to the on-display screen information storage unit 216, gives a transmittance setting request for the particular window to the hardware or OS.

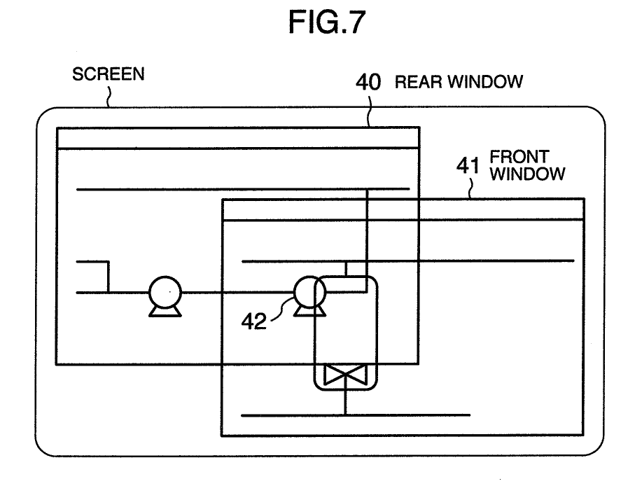

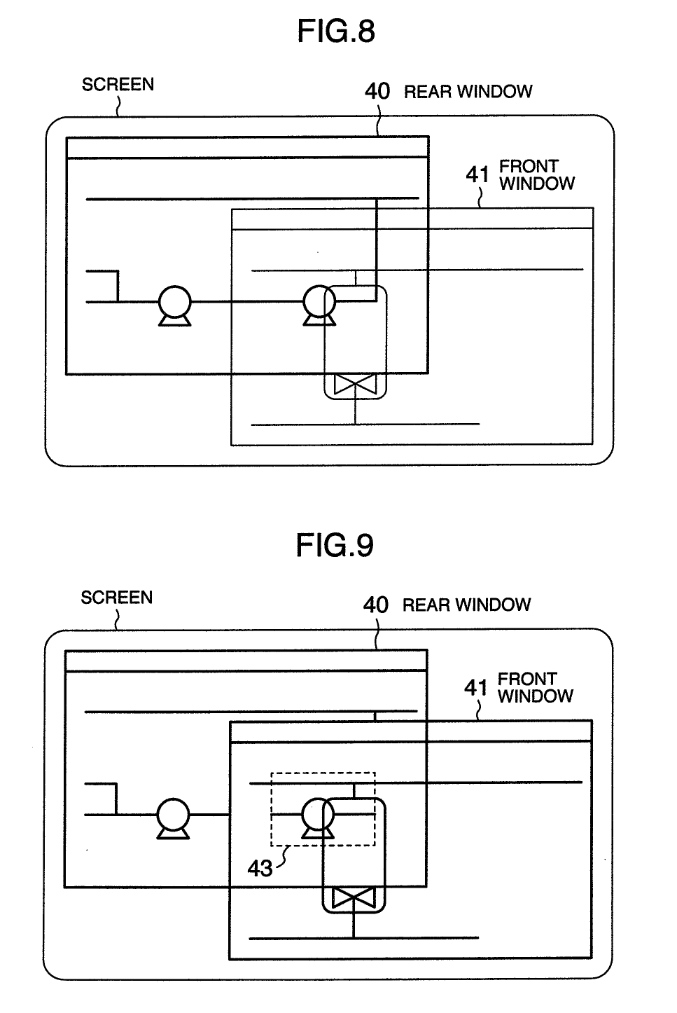

In the process, no transparent display is conducted by the display screen management unit 212 in the case the windows are not superposed with each other or the front window is higher in priority than the rear window. Specifically, in the case where the priority difference is small between the superposed windows, the transmittance is set to a comparatively small value. In the windows superposed on the monitor screen shown in FIG. 7, for example, the front window 41 is not very high in transparency, and therefore, the display factor 42 of the rear window 40 is displayed faintly. In the case where the priority difference is large, on the other hand, the transmittance is set to a large value, so that as an example of window superposition on the monitor screen in FIG. 8 shows, the display contents of the front window 41 become transparent and the contents of the rear window 40 are displayed clear and visible.

In the plant monitoring apparatus according to an embodiment of this invention, the transmittance for the priority difference shown in FIG. 5 can be freely set taking the plant size, the plant type, the frequency at which the plant status changes and the operator characteristics into consideration.

Incidentally, although the transmittance of the front window can be set for the whole window, only a part of the front window, such as a rectangular part 43 indicated by dashed line in FIG. 9, corresponding to a part set for each display factor in advance, for example, may be displayed transparently. The operator can select arbitrarily whether the front window is transparently displayed over the whole area thereof or only for a part thereof set for each display factor in advance. In the latter case, the shape of the transparent display area for each display factor is selected from a rectangle, circle, ellipse, triangle and other arbitrary figures, and the particular area is transparently displayed in units of the selected shape. The front window may be a window to be displayed or a menu window to be displayed always in a window in such a form as a bar, a pop-up or a thumbnail indicating the function to be executed.

As explained above, in the plant monitoring apparatus 20 according to an embodiment of the invention, as apparent from the data structure of the priority information shown in the tables in FIGS. 3 and 4, the whole or a part of the window superposed on the front surface can be transparently displayed based on the priority information predetermined for each window.

Specifically, in the case where the whole of the window is transparently displayed, the control unit 21 performs the transparent display operation in accordance with the priority information (FIG. 3) stored in the priority information storage unit 215 and preset for the whole window, while in the case where a part of the window is transparently displayed, on the other hand, the control unit 21 can operate in such a manner that a partial area of the front window superposed with the display factors of the rear window can be transparently displayed in accordance with the shape of the transparent display area preselected for the display factors, based on the relation between the priority information set for each display factor of the front window (FIG. 4) and the priority information set for each display factor of the rear window (FIG. 4).

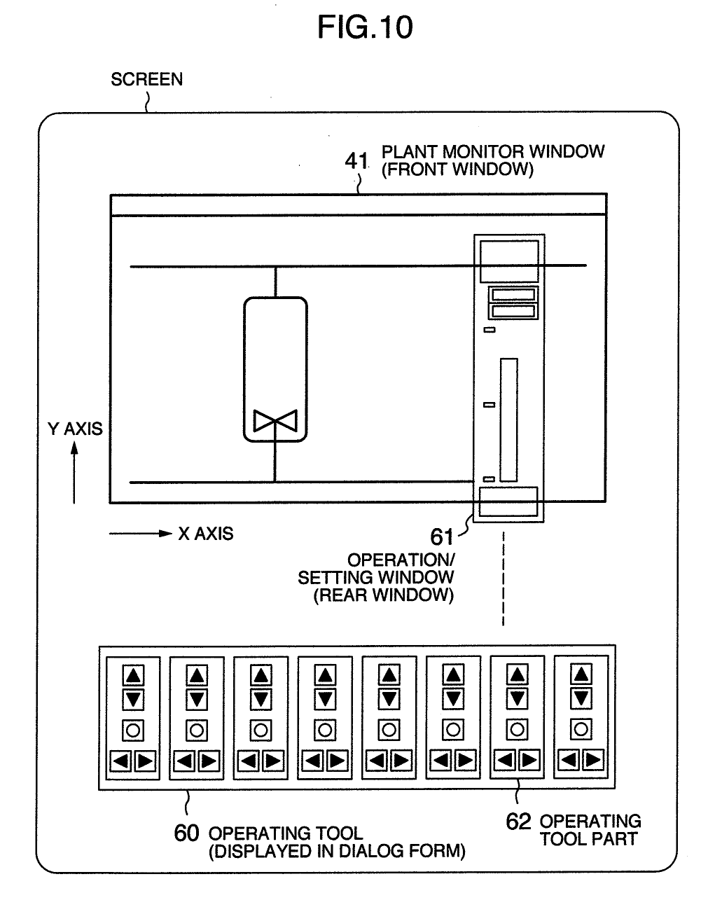

FIG. 10 is a diagram showing an example of the display screen configuration according to an embodiment of the invention, and represents the relation between the operating tool 60 and the operation/setting window 61.

In the display screen shown in FIG. 10, the operation/setting window 61 is visible by the transparent display through the plant monitoring window 41 located on the front.

The operator selects the operation/setting window 61 by way of the input unit 31, and then, the operating tool 60 (the mass of the operating tool parts 62) is displayed in dialog form. In accordance with the display position of the operation/setting window 61, the operator manipulates the operating tool part 62 displayed nearest in the direction along X axis. Thus, the operation/setting window 61 receives the input and executes a predetermined process (the control operation of the plant). In the process, the operation/setting window 61 may be display either transparently or on the front.

Specifically, the operation input acquisition unit 219 of the control unit 21 of the plant monitoring apparatus 20 retrieves the selective input of the operation/setting window 61 by the operator, and the display screen management unit 212 that has received the input, upon detection of the selective operation of the operation/setting window 61 transparently displayed, displays the operating tool 60 in dialog form on the display unit 10. The operation input acquisition unit 219 further detects the instruction input by the operator to the operation tool part 62 displayed on the display unit 10, so that the display screen management unit 212 generates and outputs a control signal for the intended plant control to the plant control system not shown.

As explained above, the plant monitoring apparatus according to an embodiment of the invention operates in such a manner that in the case where the monitor unit 14 detects a status change of the plant, the control unit 12 transparently displays at least a partial area of the window displayed in superposition on the display unit 10. Specifically, the order of priority among the windows displayed on the display unit 10 is determined based on the window type managed by the display screen management unit 212 or the display factors and the predefined transparent display conditions, so that the transparent display is conducted in accordance with the priority order.

With the configuration described above, assume that a window high in priority is hidden behind a window low in priority. Then, at least a partial area of the front window low in priority is transparently displayed, so that the important information displayed on the window high in priority can be recognized without the window display order switching operation on the part of the operator, thereby preventing the overlooking and the recognition delay. In the process, the control unit 21 determines whether the transparent display is required or not from the priority relation between front and rear windows, and determines the transmittance of the front window in accordance with the magnitude of the priority difference between the superposed windows.

In the case where the priority of the rear window is higher than that of the front window and the priority difference is large between them, on the other hand, the transmittance is set to a high value. In the case where the priority difference is small, on the other hand, the transmittance is set to a low level. In this way, the optimum transmittance for display can be determined in accordance with the prevailing situation. In this case, the front window is operated primarily, and therefore, the contents of the rear window can be confirmed while continuing the operation of the front window.

Incidentally, by setting the transmission range for each window type in advance, the transmission of the whole or partial front window low in priority can be selected, and the transparent display is made possible in accordance with this setting. In the case where the whole window is transparently displayed, the transmittance is determined from the priority of the whole window, while in the case where the partial transparent display is selected, on the other hand, the transmittance is determined from the relation between the priority for each display factor of the rear window and the priority for each display factor of the front window.

Also, the priority may be determined by such factors as the maintenance timing of the process device 30, the maintenance timing such as the operation time limit or the start and end of the construction work, the instruction on the production amount, the designation of the shipment time or the managemental or operational instruction for operator shift, as well as the plant status.

Also, with the plant monitoring apparatus 20 according to an embodiment of the invention, assume that a window (the operation/setting window 61 in FIG. 10) with at least a partial area thereof transparently displayed is selected on the display unit 10. An operation tool 60 for the plant displayed on the transparently displayed window is displayed, and the operation of the plant operation tool part 62 corresponding to the operation tool 60 is detected and the plant control operation can be performed as intended. As a result, the operator operation is made possible without repeating the window select operation while presenting a great amount of information to the operator, and therefore, both the operability and the operating convenience are improved.

Incidentally, the functions of each component block of the control unit 21 shown in FIGS. 1 and 2 may be implemented wholly with software or at least partly with hardware. The data processing in the priority calculation unit 210, the transmittance setting request generating unit 211, the display screen management unit 212 and the plotting display control unit 213, for example, may be executed either on the computer according to one or a plurality of programs or at least partly with hardware.

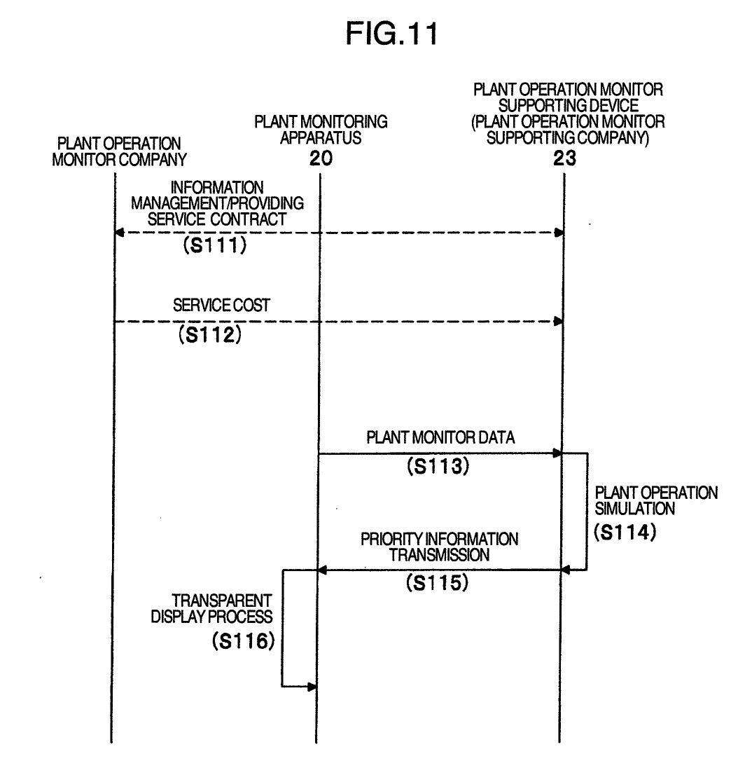

FIG. 11 is a sequence chart for explaining each process of the plant operation monitor supporting method according to an embodiment of the invention.

This embodiment illustrates a case in which the plant operation monitor company for managing and operating the plant monitoring apparatus 20 and the company for supporting the plant operation monitoring are independent of each other. Both companies have a server (the plant monitoring apparatus 20, the plant operation monitor supporting device 23) connected through the network such as WAN, and mutually monitor their plant operations under an agreement.

In the sequence chart of FIG. 11, the plant operation monitor company signs a service contract with the plant operation monitor supporting company for managing and providing the information (step S111), and pays the cost of the plant operation monitor supporting service as a consideration to the plant operation monitor supporting company (step S112).

The “plant operation monitor supporting service” is defined as a service to acquire the monitor data on the plant in operation or detect a malfunction or a sign thereof which is the information processing work providing service originally conducted by the plant operation monitor company, the guidance for the optimum operation formed as the result of plant data accumulation and statistical management, or the operation guide for preventing the expected situations by advance simulation of events estimated from the plant data. In other words, this service provides the support information for enabling the plant operation monitor company to carry out a better plant operation, the timing of providing the service, and the priority information for transparent display to provide the service.

In the case under consideration, a business model is employed in which the plant operation monitor supporting device 23 generates, for example, the priority information shown in FIG. 3 by simulation, and supplies it through the network 27 to the plant monitoring apparatus 20, which conducts the transparent display of the superposed windows based on the priority information supplied thereto.

Specifically, the plant operation monitoring method according to an embodiment of this invention is used for the plant operation monitoring system 1 wherein, as shown in FIG. 1, for example, the plant monitoring apparatus 20 for displaying a plant monitor screen having a plurality of windows in superposition with each other is connected, through the network 27, to the plant operation monitor supporting device 23 for supporting the monitoring of the plant operation by the plant monitoring apparatus 20. As shown in the sequence chart of FIG. 11, for example, this plant operation monitoring method comprises the step (step S113) for the plant monitoring apparatus 20 monitoring the plant operation and transmitting the acquired monitor data (plant monitor data) to the plant operation monitor supporting device 23, the steps (steps S114, S115) for the plant operation monitor supporting device 23 receiving the monitor data through the network 27, simulating the operation based on the received monitor data and generating and transmitting the priority information for each window or each display factor at the time of displaying the plant monitor screen having the windows in superposed relation to each other in accordance with the result of the simulation, and the step (step S116) for the plant monitoring apparatus 20 receiving the priority information, calculating the priority difference for each window in superposition or each display factor based on the received priority information and transparently displaying at least a partial area of the window displayed in superposition in accordance with the transmittance preset for each calculated priority difference.

In the plant operation monitoring method according to this embodiment of the invention, the plant monitoring apparatus 20 causes the plant operation monitor supporting device 23 to take charge of the load for the information processing including the monitoring, analysis and simulation of the plant operation status. In this way, the plant monitoring apparatus 20 can concentrate on the plant operation process. As a result, the throughput is improved, the overlooking or delayed recognition of the critical plant status change can be corrected, and the efficient operation is made possible without interrupting the plant operation performed by the operator.

Also, the plant operation monitor company receives the information processing service which otherwise should be conducted by itself, and therefore, the manager or the operator of high skill is not required, thereby making possible the efficient plant management.

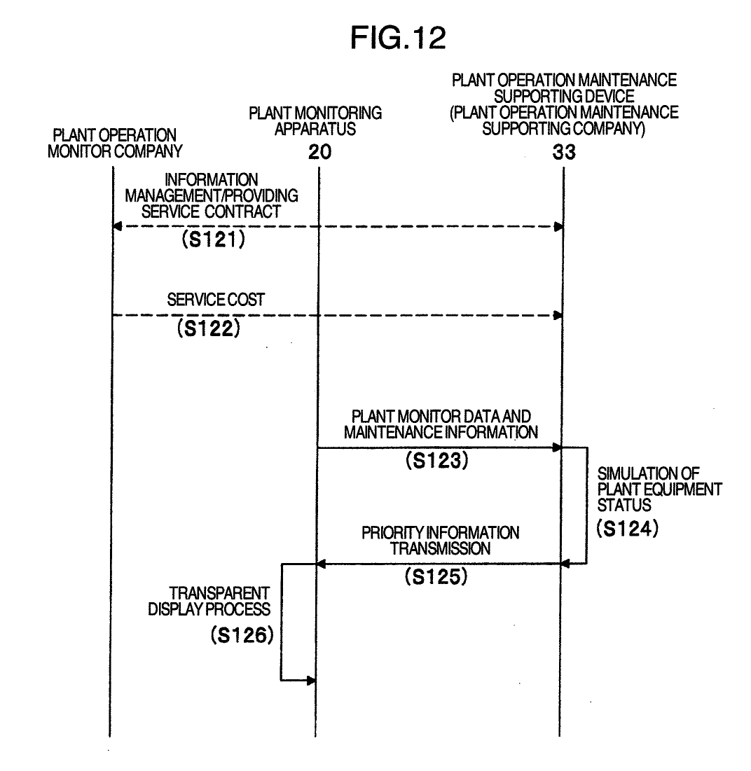

Incidentally, the aforementioned embodiment of the invention represents the plant operation monitoring method for monitoring a plant. Nevertheless, this invention is not limited to the plant monitoring operation, but also applicable to the plant maintenance through a similar process. The sequence of this application is shown in FIG. 12.

Specifically, in the maintenance application, a plant operation monitor company signs an information processing and providing service contract in advance with a plant maintenance supporting company (step S121), and in accordance with this contract, the plant operation monitor company pays a predetermined price to the plant maintenance supporting company as a consideration for the maintenance supporting service in the plant monitor operation (step S122).

The “maintenance supporting service in the plan operation monitor operation” is the service for displaying, at appropriate timing according to the priority order, the information processing service and the supporting information providing service. The “information processing service” is the service for monitoring the data on the plant in operation, for example, and providing the information on the management including the change in the operating equipment to assure uniform utilization of the equipment in the presence of a plurality of replacement equipment and the information on the maintenance including the detection of a situation requiring the equipment maintenance. The “service for providing the supporting information”, on the other hand, is the service for accumulating the plant data, and providing the information including the guidance for the optimum maintenance plan as the result of statistical management, the preventive maintenance guide against a situation expected by prior simulation of an event as an extension of the plant data and other information enabling the plant operation monitor company to monitor the plant operation in a better way or to realize a low maintenance cost.

This embodiment represents a business model in which the plant operation monitoring system 1 shown in FIG. 1 is further connected with a server (plant operation maintenance supporting device 33) managed and operated by the plant operation maintenance supporting company through the network 27, and the plant operation maintenance supporting device 33 generates the priority information shown in FIGS. 3 and 4, for example, by simulation, while the plant monitoring apparatus 20 transparently displays the superposed windows based on the priority information thus provided.

Incidentally, in the sequence chart of FIG. 12, steps S123 to S126 correspond to steps S113 to S116, respectively, shown in FIG. 11. Therefore, these steps represent a similar process and are not described again.

It should be further understood by those skilled in the art that although the foregoing description has been made on embodiments of the invention, the invention is not limited thereto and various changes and modifications may be made without departing from the spirit of the invention and the scope of the appended claims.

1. A plant monitoring apparatus comprising:
a display unit for displaying a plant monitor screen including a plurality of windows in superposed relation with each other;
a monitor unit for monitoring a status change of a plant; and
a control unit for transparently displaying at least a partial area of the windows displayed in superposed relation with each other on the display unit upon detection of a status change of the plant by the monitor unit.

2. The plant monitoring apparatus according to claim 1,
wherein the control unit causes the whole or a part of the superposed front window to be transparently displayed based on the priority information preset for each window.

3. The plant monitoring apparatus according to claim 1,
wherein the control unit causes the whole of the window to be transparently displayed in accordance with the priority information preset for the whole of the window and a part of the window to be transparently displayed based on the relation between the priority information set for each display factor of the front window displayed in superposition and the priority information set for each display factor of the rear window displayed in superposition.

4. The plant monitoring apparatus according to claim 1,
wherein the control unit calculates the priority difference for selected one of each superposed window and each display factor based on the priority information set for selected one of each superposed window and each display factor, and causes the display unit to transparently display the window in accordance with the transmittance preset for each calculated priority difference.

5. The plant monitoring apparatus according to claim 1,
wherein the window displayed in superposition includes a menu window prompting the selective input of the monitor screen, and
wherein the control unit calculates the priority difference for each superposed window based on the fixed display priority information assigned to the menu window, and causes the display unit to transparently display at least a partial area of the menu window in accordance with the transmittance preset for each calculated priority difference.

6. The plant monitoring apparatus according to claim 1,
wherein the control unit switches the superposed window display on the display unit to the superposed display for transparently displaying at least a partial area of the window in the case where the monitor unit detects a status change of the plant.

7. The plant monitoring apparatus according to claim 1,
wherein the control unit, upon selective operation of the window with at least a partial area transparently displayed, displays an operating tool for the plant on the transparently displayed window and controls the plant as intended by detecting that the operating tool has been operated.

8. A plant operation monitoring method for a plant operation monitoring system wherein a plant monitoring apparatus for displaying a plant monitor screen having a plurality of windows displayed in superposed relation with each other and a plant operation monitor supporting device for supporting the monitoring of the plant operation by the plant monitoring apparatus are connected to each other through a network, comprising the steps of:
the plant monitoring apparatus monitoring the operation of the plant and transmitting the monitor data acquired to the plan operation monitor supporting device;
the plant operation monitor supporting device receiving the monitor data through the network, simulating the plant operation based on the monitor data received and generating and transmitting the priority information for selected one of each superposed window and each display factor for the superposed display of the plant monitor screen by the plant monitoring apparatus in accordance with the result of the simulation; and
the plant monitoring apparatus receiving the priority information, calculating the priority difference for selected one of each superposed window and each display factor based on the received priority information, and transparently displaying at least a partial area of the superposed window in accordance with the transmittance preset for each priority difference calculated.
